(19) United States
(12) Patent Application Publication
(10) Pub. No.: US 2014/0247965 A1
(43) Pub. Date: Sep. 4, 2014

(54) INDICATOR MARK RECOGNITION

(71) Applicant: DESIGN BY EDUCATORS, INC., WATERTOWN, MA (US)

(72) Inventors: Isaac Van Wesep, Watertown, MA (US); Cameron Ehrlich, North Hills, CA (US); Matthew Griffin, Berkeley, CA (US)

(73) Assignee: DESIGN BY EDUCATORS, INC., WATERTOWN, MA (US)

(21) Appl. No.: 14/195,307

(22) Filed: Mar. 3, 2014

Related U.S. Application Data
(60) Provisional application No. 61/772,196, filed on Mar. 4, 2013.

(51) Int. Cl. G06K 9/00; G06K 9/22

(52) U.S. Cl. CPC G06K 9/00442; G06K 9/228
USPC 382/103

(57) ABSTRACT

A method and system for deciphering answer sheets for standardized tests and surveys using multiple-choice answer sheets. Multiple-choice answer sheets are typically scanned by automatic scanning machines, where the answers are deciphered and the information is gathered. An improved answer sheet includes a character, such as a symbol, a letter or a number in each bubble-type space on an answer sheet. A device, which may be a hand-held device, scans the marked-up answer sheet. Bubbles that are filled in may sometimes be hard to distinguish from un-marked spaces. The device that scans the answer sheets is equipped with optical mark recognition (OMR) software to detect marks. The device is also equipped with optical character recognition (OCR) software. If a bubble is not marked, the OCR software detects the character and correctly interprets the bubble as not marked. This allows for correct counting of the number of answers marked per sheet.

### CROSS-REFERENCE TO RELATED APPLICATIONS

This application claims the benefit of the following United States Provisional patent application, which is hereby incorporated by reference herein in its entirety: U.S. Provisional Patent Application Ser. No. 61/772,196, filed Mar. 4, 2013.

### FIELD OF THE DISCLOSURE

This disclosure is related to assessments, surveys, and data collection in industries such as, but not limited to, education, healthcare, international development, anthropology, politics, academic research, entertainment, retail sales, and hospitality, and the optical scanning of marks and characters on such assessments and surveys using computing facilities, such as a mobile device, and scanning and copying hardware and software.

### BACKGROUND

Multiple-choice testing has become a common format for standardized testing. Standardized testing is a prevalent method of assessing the mastery of students, as well as the quality of school performance. However many teachers have complained that the focus on standardized testing has encouraged teachers to “teach to the test” rather than deliver engaging lessons personalized to the individual students in their classroom. As a result, teachers are looking for ways to use assessment in the classroom to assess student mastery more frequently than standardized tests. However, there are currently several barriers to teachers being able to use in-class assessments to drive instruction, including speed limitations. Unless daily assessments can be delivered and analyzed quickly, teachers do not have enough time to make daily assessment part of their lesson plan.

Quickly gathering assessment results data from paper response forms has traditionally only been possible with expensive hardware scanners and software systems, or with computer-connected document cameras. Because of the expense of these systems, each school may only possess one or a few such systems, preventing teachers from using them on a frequent basis to assess their students. Teachers need a way to use data to assess their students frequently, without the need to use these expensive machines.

In the past few years, as mobile device technology has improved to include high-quality imaging technology (cameras and associated software and firmware) and powerful processors, it has become possible to adapt computer-based optical scanning software libraries and algorithms to mobile device platforms. This has opened the door to mobile optical scanners, which turn a camera-equipped smartphone or tablet into an optical mark scanner. The benefits of mobile scanning devices extend beyond educational assessment to the fields of surveys, field research, ethnography, healthcare, and all other professions involved in the gathering of information.

What is needed is a method and system of scanning marks (such as those on paper response forms) with a mobile device's camera, or associated camera, that is accurate in varying light conditions, that is enabled to scan, recognize and analyze response form marks made with a variety of marking media (such as pencil, pen, or dry-erase marker), and that can scan human-made marks without necessitating stringent requirements on the precision of the marks (such as filling out a response form “bubble” completely and within the borders of the demarcated bubble).

### SUMMARY

In embodiments, the methods and systems disclosed herein may include detecting marked answers for questions, such as on a answer sheet response form, and taking at least one markable answer sheet having a plurality of spaces for answers on the at least one markable answer sheet, where each space further comprises a mark recognizable by optical character recognition (OCR) software where each mark comprises a reverse indicator symbol, and scanning the at least one marked answer sheet with optical mark recognition (OMR) software. The number and location of answer marks may be cataloged on the scanned at least one marked answer sheet, wherein if the reverse indicator symbol is detected, the corresponding space is counted as unmarked.

At least one of the number and location of cataloged answer marks on the scanned at least one marked answer sheet may be compared to at least one of the number and location of expected answer marks, and if the comparison reveals a discrepancy, the at least one marked answer sheet may be reviewed with the OCR software to determine spaces with marks recognized by the OCR software. In embodiments, the number of answer marks recognized may be corrected to account for the expected number of marks.

In embodiments, a dataset corresponding to correct answers for responses on the answer sheet may be generated and used to determine the correctness of answers marked on the at least one marked answer sheet. OCR training data may be generated to improve the OCR software.

In embodiments, the step of scanning may generate a scanned image and further comprise correcting the scanned image for keystoning. The scanned image may be transformed from gray-scale to a black-and-white image. In embodiments, the steps of scanning, counting, comparing the number, reviewing and comparing the sum may be accomplished with a hand-held device, such as a smart phone, cellular phone, tablet computing device, portable computing device, or some other type of hand-held device that is capable of recording an image of an answer sheet.

In embodiments, the methods and systems disclosed herein may include providing at least one markable answer sheet, where the at least one markable answer sheet comprises a plurality of spaces to mark answers for the questions, wherein each of the plurality of spaces further comprises a character recognizable by optical character recognition (OCR) software. The at least one marked answer sheet may be scanned with optical mark recognition (OMR) software, and a number of answer marks recognized by the OMR software counted on the at least one marked answer sheet. The at least one scanned marked answer sheet may be reviewed with OCR software to determine a number of characters recognized by the OCR software in the plurality of spaces, and a number of answers on the at least one marked answer sheet and a number of unmarked spaces determined. A number of questions not answered may be determined by comparing the number of answers on the at least one marked answer sheet and the number of characters recognized in the plurality of spaces. In embodiments, a discrepancy between the number of answers determined and the expected number of answers on the at least one marked answer sheet may be determined.

In embodiments, the OMR software may be adapted for recognizing markings made on the markable answer sheet by at least one of a pencil, an ink pen and a dry-erase marker. The markable answer sheet may be suitable for at least one of an educational assessment, a political survey, a consumer survey and a data collection project. The plurality of spaces may comprise fillable bubbles on the markable answer sheet.

In embodiments, the system disclosed herein may include at least one processor having access to a non-volatile memory, a computer program stored in the non-volatile memory, the computer program comprising software suitable for scanning a marked answer sheet, the computer program including software suitable for optical mark recognition (OMR) and optical character recognition (OCR), a scanner in operable connection with the at least one processor, the scanner suitable for capturing an image, and a library stored in the non-volatile memory or other memory accessible to the at least one processor, the library comprising a plurality of images of characters recognizable by OCR software. The scanner may be suitable for capturing an image of at least one marked answer sheet, the at least one marked answer sheet comprising a plurality of spaces for answers, each of the plurality of spaces including a mark recognizable by the OCR software, and the system may be suitable for cataloging the number and location of answers marked on the at least one answer sheet with the OMR software and for cataloging a number of characters in the plurality of spaces recognizable by the OCR software.

In embodiments, the software may be suitable for summing the number of spaces marked on the at least one answer sheet and for summing the number of characters counted in the plurality of spaces recognizable by the OCR software, and may be stored in memory accessible to the at least one processor, the software suitable for transforming a scanned image from gray-scale to black and white. The software stored in memory may be accessible to the at least one processor, the software suitable for correcting keystoning of scanned images and for determining bounding boxes on the at least one answer sheet.

In embodiments, the answer sheet may be suitable for at least one of an educational assessment, a political survey, a consumer survey and a data collection project.

In embodiments, the system described herein may be mounted within a mobile device, wherein the mobile device is selected from the group consisting of, but not limited to, a mobile phone, a smart phone, a tablet computer and a portable computer.

In embodiments, an article of commerce made in accordance with the methods and systems described herein may comprise a markable answer sheet having a plurality of spaces for answers on the at least one markable answer sheet, at least a portion of the plurality of spaces further comprising a mark recognizable by optical character recognition (OCR) software, wherein at least a portion of the marks comprise a reverse indicator symbol and wherein the reverse indicator symbol is positioned such that if the reverse induction symbol is detected, the corresponding space is to be counted as unmarked by the OCR software.

While the invention has been described in connection with certain preferred embodiments, other embodiments would be understood by one of ordinary skill in the art and are encompassed herein.

### BRIEF DESCRIPTION OF DRAWINGS

FIG. 1 illustrates the appearance of a well-made mark and the appearance of types of poorly-made marks

FIG. 2 illustrates an un-marked bubble containing a Response Indicator Symbol (RIS), and two other bubbles each containing an RIS that has been obscured by a response mark.

FIG. 3 depicts a simplified example of an optical mark recognition scanner failing to recognize a mark made on a response form if the mark reflects too much light into the image capture component of the scanner.

FIG. 4 illustrates an example of a response form and the elements on the response form used in a conventional OMR analysis.

FIG. 5 illustrates an example embodiment of the disclosure using OMR and OCR together with a logical engine and an external dataset to recognize the existence of response marks on a response form.

FIG. 6 presents a simplified diagram of components of the present disclosure.

FIG. 7 depicts a database and a structure for the database.

FIG. 8 depicts an example sequence for detecting discrepancies in an expected answer count.

FIG. 9 illustrates the components of the scanning software (scanner) used in the present disclosure.

FIG. 10 illustrates information that may be included in the scanner's dictionary element of the present disclosure.

FIG. 11 illustrates an overview of a conventional OCR process.

FIG. 12 illustrates a typical image-processing library and the components of such a library as may be used in the present disclosure.

FIG. 13 illustrates the information contained in an external dataset that may be associated with the present disclosure.

FIG. 14 illustrates an overview of a conventional OMR process.

FIG. 15 depicts an example of data that may be included in a response list, which is the output of an OMR scan as used in the present disclosure.

FIG. 16 depicts a rescanning and optical character recognition process.

### DETAILED DESCRIPTION

In embodiments of the present disclosure, methods and systems are provided for improving the accuracy of optical scanning of marked response forms such as multiple-choice quizzes, surveys, and other types of informational and response forms where a user's responses may be indicated by marking or filling-in specific response fields on the form (“bubbles”). Bubble as used herein includes, but is not limited to, a region of a response form intended to receive a form of user response, such as a mark, check, darkening, circling of the region or some other type of response indicator. The response region of the bubble, as used herein, may be a square, rectangle, circle, oval, or some other indicated area of a response form, including a bounded or unbounded area within the response form within which a user's response mark(s) is to be made. A bubble may optionally include within it a pre-defined symbol, such as a number, letter or other symbol.

Traditional optical scanning of response forms proceeds by running an optical mark recognition (OMR) analysis on an image of the response form, to locate the bubbles that have been filled in (marked) on the form. A data list of which bubbles were found to contain marks is then returned to the scanner, and the scanner sends this data list to a software application that uses the data list for its intended purpose of recording a user's responses recorded on the scanned response form.

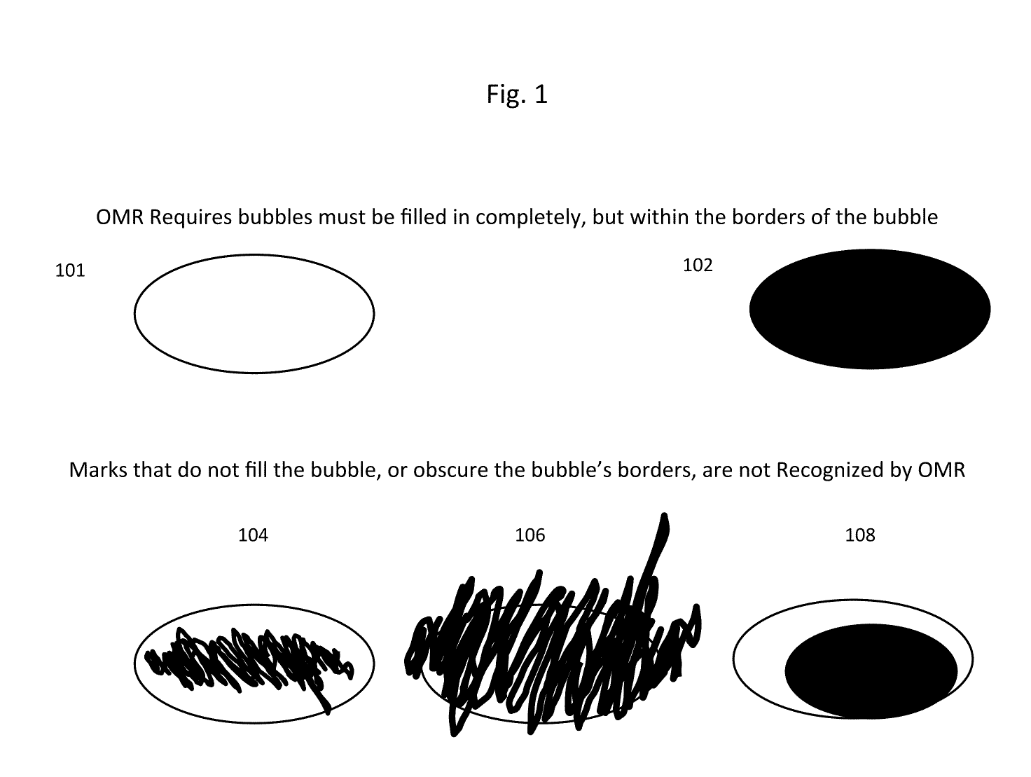

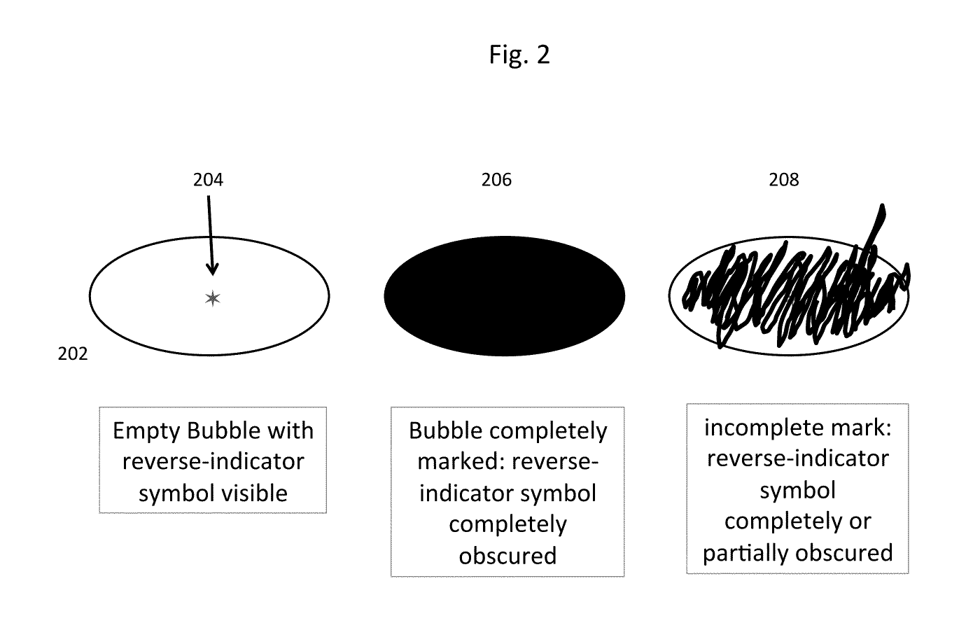

OMR software has been used extensively to scan paper quizzes, tests, surveys, and other types of response forms, but it has the limitation of requiring that the marks made on response forms be highly precise, for example as regards the marks' relation to the defined perimeter of a bubble. As shown in FIG. 1, in cases where the response form is comprised of rows of circles or other bubble shapes 101 to be filled in as a response to a given question or questions, those bubbles must be filled in completely 102, for example, as depicted in the entirely blacked bubble 206 in FIG. 2. The traditional OMR process may have the further limitation of requiring that the marks also not extend beyond the borders of a bubble 106. Failure to completely fill a bubble 104, 108, 208 or the presence of marks beyond the boundaries of a bubble 106, 208 may result in the OMR scanner not recognizing the mark. This condition causes the OMR software to fail to correctly record the presence of the mark, called reading a “false blank.”

Because of the limitations of OMR mark recognition, it is possible for the OMR process to fail to recognize a mark inside a bubble. Typically, OMR could fail to read a mark for one or more reason. For example, a mark may not be read by an OMR system because the recorded mark on the response form does not fill a sufficient area of a bubble, or because the mark overflows the boundary of a bubble, or because the mark on the response form is not dark enough. This last scenario, in which a mark recorded on the response form is not perceived and recorded by the OMR system dark enough to be indicative of a user's recorded response (i.e., is read as having no recorded mark made by a user), may occur because the original mark itself is light in color, or because the material with which the mark was made reflects or refracts light into or away from the imaging device when the response form was scanned, causing the mark in the recorded image to appear light in color or to record as a bubble devoid of a user response.

Mobile devices, such as smart phones, computing tablets, and other mobile devices, with onboard cameras are capable of high-resolution imaging and make possible migrating from OMR scanning technology that is dependent upon stationary computer and hardware systems (e.g., personal computers (PC), scanners and associated, non-mobile hardware) to mobile systems. However, mobile scanning presents several challenges not present in PC or hardware scanning situations. For example, environmental variables including, but not limited to, hand motion, scanning angle, shadow-lines, light sources, and variable marking media all present challenges to existing Optical Mark Recognition (OMR) technology, when deployed on a mobile device to scan paper response forms.

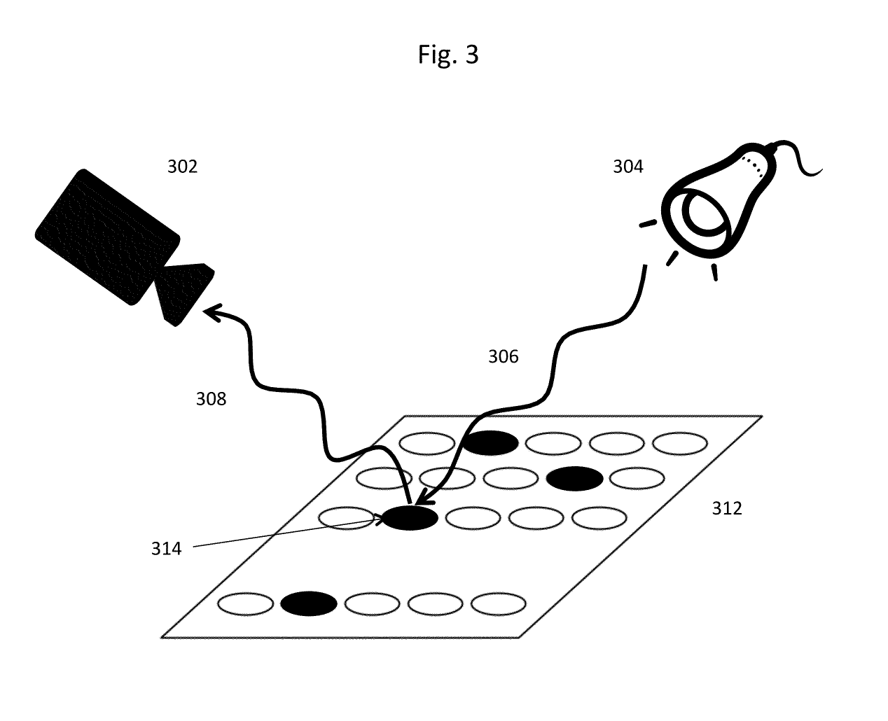

Referring to FIG. 3, the choice of marking medium used to mark paper response forms 312 can impact the success of OMR scanning of the response forms. Dark-colored ink is an ideal marking medium, but marks made with other more common marking media can be difficult for an OMR scanner to detect. Graphite presents an especially serious problem to mobile scanning Graphite (for example, the #2 pencil) is the dominant marking medium in K-12 and higher-education. Graphite is also a light-reflective substance. In a mobile environment, where the light source 304 is variable, marks made with graphite pencils can reflect light 306, 308 back into the image-capture device 302, making the mark 314 appear as bright or brighter and/or lighter than the paper. This will often cause the OMR scanner to read a “False Blank.” Other marking media can also be difficult for an OMR scanner to detect. Any marking medium that is not dark in color may go undetected by the OMR scanner, causing a “False Blank” reading.

The reading of a “false blank” as described herein presents a serious problem to users of OMR scanners. It creates the need to manually repair the data output of the scan (if possible), or deleting and re-scanning the sheet (if possible).

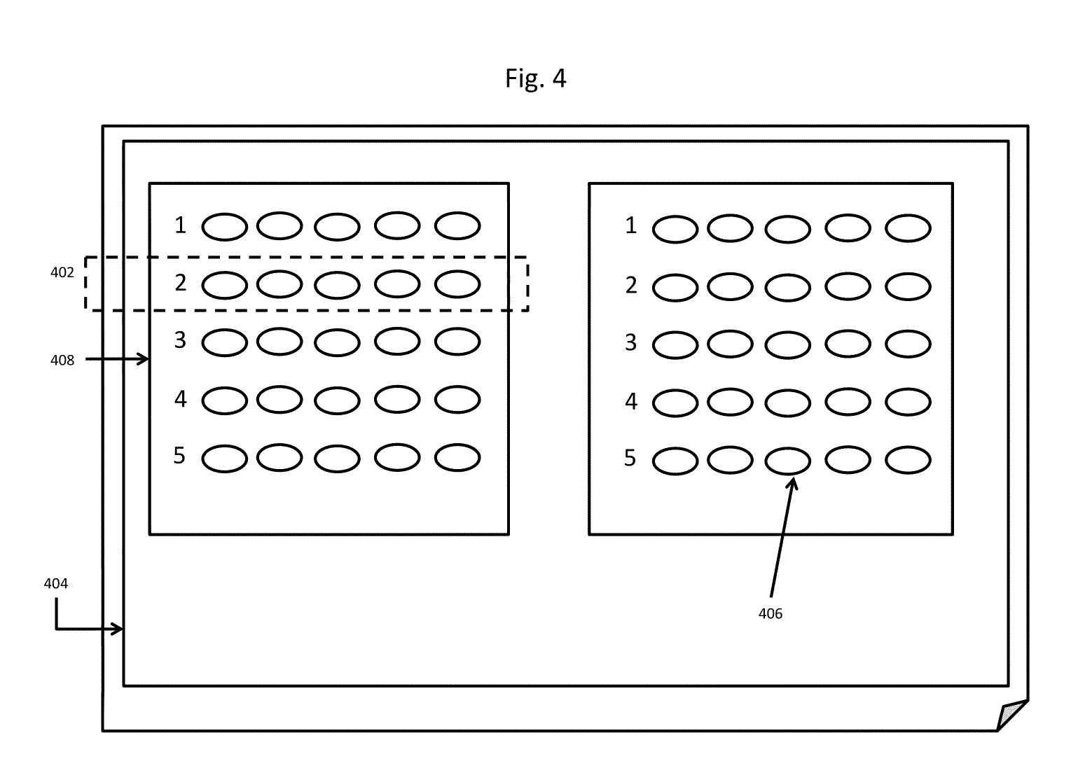

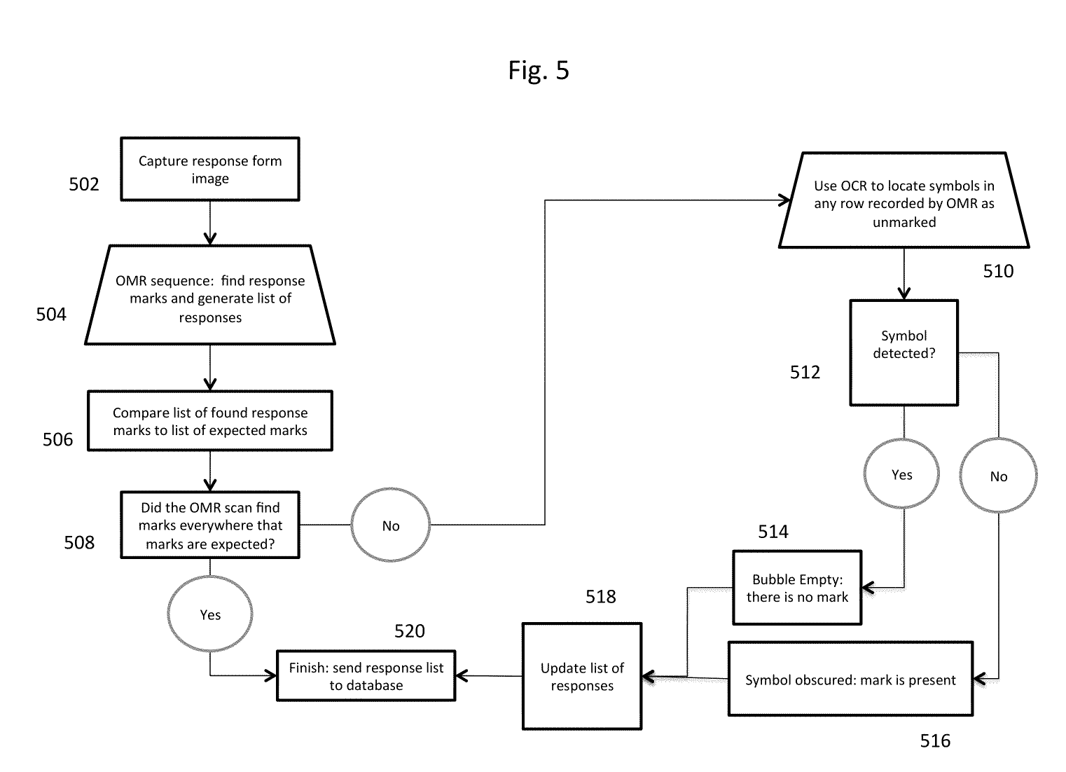

The present disclosure improves upon the accuracy of optical mark recognition (OMR) scanning based at least in part by employing a novel sequence of operations that recognizes marks even if they are unable to be correctly recognized by an OMR scanner. Referring to FIG. 4, in an embodiment, a response form may be comprised of bounding boxes 404, 406 and bubbles 406. Inside each bubble there may be a symbol, such as a star, a cross, a circle, or letter. Using the methods and systems of the present disclosure, as depicted in FIG. 5, a conventional OMR scan 504 may first be run on an image 502 of the response form. This result may then be compared to a list of expected marks provided by the user 506. If the OMR scan does not recognize a mark where a mark is expected 508, then an optical character recognition (OCR) scan 510 is run on that area of the response form, searching for the symbol inside each box or bubble. If the OCR scan fails to find a symbol inside a given bubble, for example, then it is determined 516 that the symbol was not found because it is obscured by a mark in the bubble. Given that a mark was expected to be found by the OMR scanner, and the OCR scanner cannot find the symbol inside the bubble, the absence of the symbol indicates the presence of a mark. In so doing, marks may be found that conventional OMR scanning would miss. In an embodiment of the present disclosure, the OCR step may optionally be performed only on areas where no mark was found by the OMR scan. Alternative methods include, but are not limited to, running the OCR scan concurrently with the OMR scan on all the bubbles within a response form, and then comparing the results of both scans to arrive at a final determination of whether or not a mark is present. According to the methods and systems of the present disclosure, the OCR process may be used alone to detect the presence or absence of marks using similar logic as described herein. Detecting the presence or absence of the symbol within each bubble may be sufficient to determine whether or not a response mark has been made in that bubble. Such combinations of traditional OMR and OCR may provide a higher degree of accuracy than either process by itself.

In an example use of the methods and systems of the present disclosure, a user may create a quiz or survey, defining the number of questions to be answered, and if applicable also indicate which responses are correct. The user may provide a response form to each of a plurality of respondents, and each respondent may then mark his or her response form by coloring in their choice of bubbles provided on the form. Completed response forms may be collected and presented to an image-capture device such as a document scanner or the camera on a laptop or smartphone. The term camera, as used herein, refers to any image-capture device, for example a camera installed in a document scanner, a mobile phone or tablet, in a laptop computer, or some other device, including an image-capture device that is self-contained, such as a document cam or a hand-held camera. It is also understood that the methods and systems of the present disclosure do not require a digital image-capture device in order to function, only that the present disclosure may utilize digital image-capture devices, and can also utilize an image file in the absence of an image-capture device.

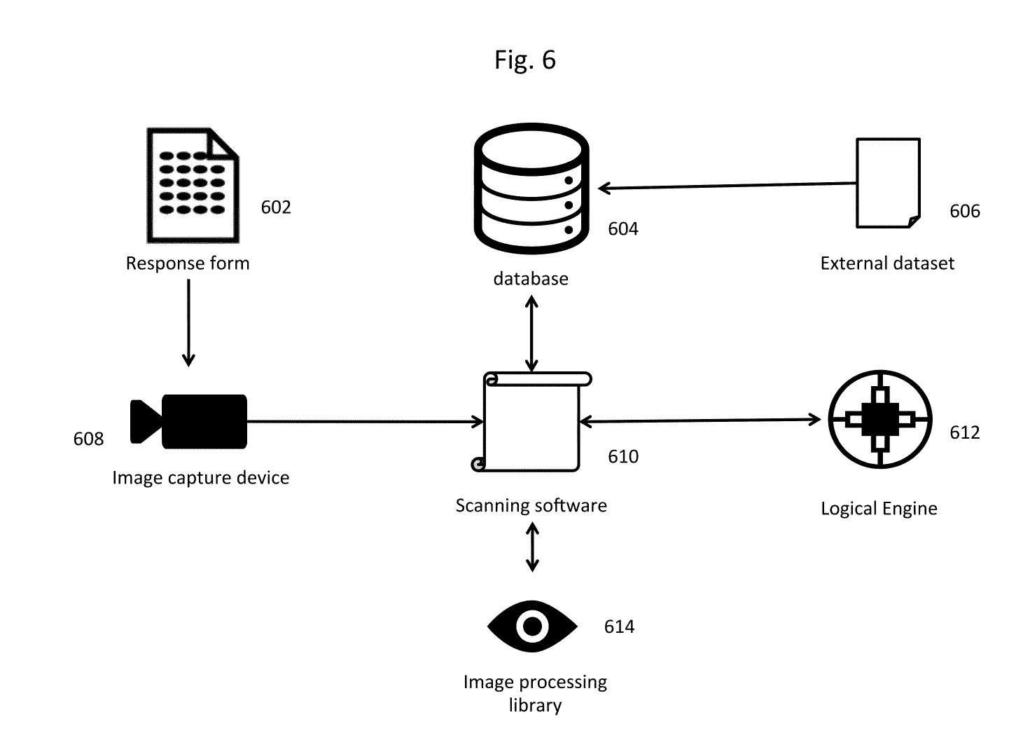

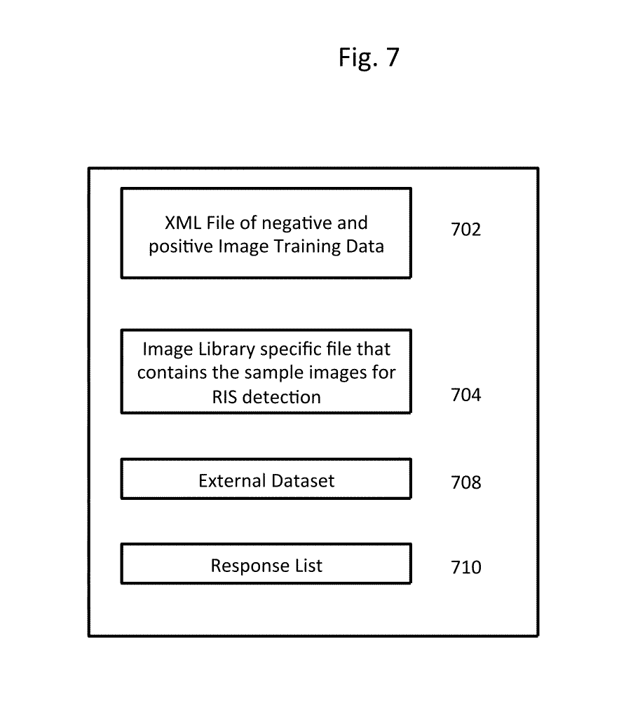

Once an image of a response form has been captured, that image may be analyzed and the results of the image analysis reported to the user in the form of a score or an itemized list of the responses found on the response form. Responses may contain any combination of types of responses: multiple choice (where the respondent marks one or more bubbles out of a group of choices), yes/no (choosing one or the other of two possible choices), and so forth. Referring to FIGS. 6 and 7, the image of the response form may be analyzed using combinations of a user-generated external dataset 606, 708, a logical engine 612, and differing modes of mark recognition, for example optical mark recognition (OMR) and optical character recognition (OCR) both of which are provided by an image-processing library 614. A database 604, and scanning software (the scanner) 610 may also be used, for example the external dataset may contain information in addition to the number of expected marks (responses), such as a list of the correct responses, if the response form is a quiz or test or a list of values to assign to different responses, or some other type of data.

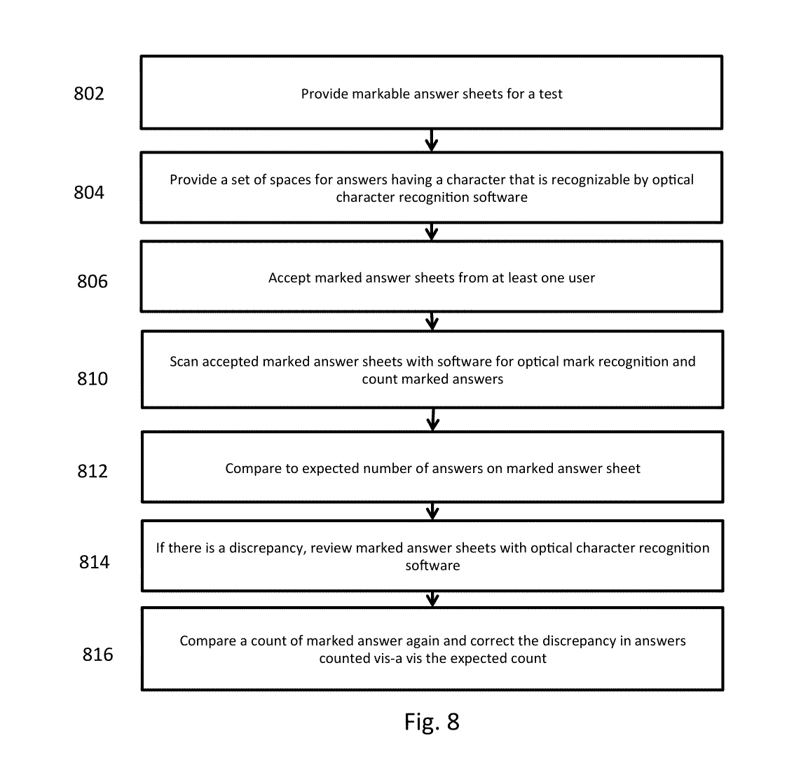

Note that the logic should account for the expected number of answers and the expected number of OCR-recognized characters. In one example, and referring to FIG. 8, in a two question, true/false test or opinion survey 802 using a typical bubble-type answer sheet 804, two marked bubbles or answers and two unmarked bubbles or answers are expected, that is, two characters to be returned on the answer sheet by a user 806. The accepted marked answer sheets are scanned with software for optical mark recognition, the marked answers counted 810, and the expected number of answers provided on the answer sheet compared to the expected number 812. Continuing the example, two answers are therefore expected, as well as two characters. If there is a discrepancy, the marked answer sheets are next reviewed with OCR software 814. One logical discrepancy would be for a returned sheet to have a single marked bubble or answer, in which case one would expect the software to recognize three characters. Following the OCR, the marked answers are again counted and compared to the expected count and any discrepancy in answers counted vis-a vis the expected count 816 corrected.

In another example, a larger range of answers may include five, as in a respondent invited to choose one of A, B, C, D or E. If the survey or test includes 5 questions, one expects a marked answer sheet to have 5 marked answers or bubbles picked up by the OMR software and 20 unmarked bubbles, i.e., characters recognized by the OCR software. If one question is not answered, then OMR would pick up 4 marks and the OCR software should pick up 21 characters, i.e., unmarked bubbles. In these examples, there is thus a one-to-one correspondence between a missing answer and an additional recognized character.

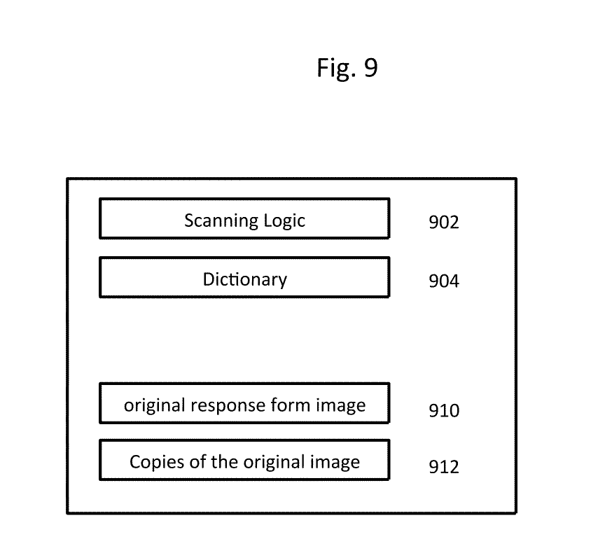

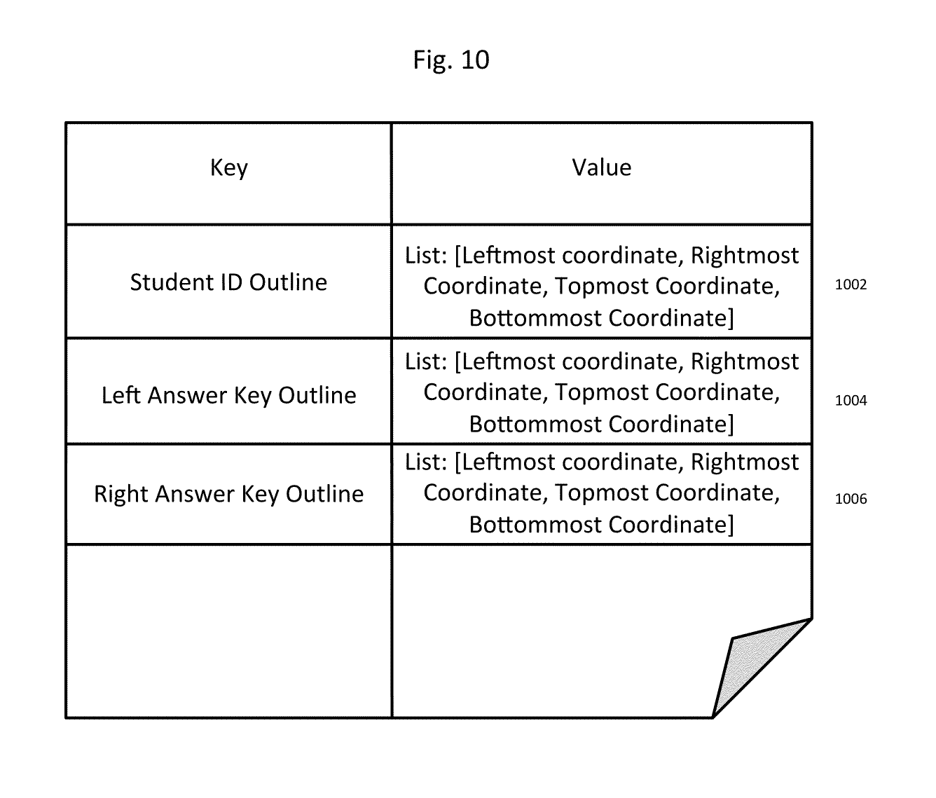

Referring to FIG. 9, scanning software (the scanner) may include scanning logic 602 that is capable of making function calls to the image-processing library. The scanner may also hold the image of the response form to be scanned 910 and be capable of storing images 912 generated by the image-processing library. As shown in FIG. 10, the scanner may further include a dictionary 904 containing values 1002, 1004, 1006 that define the size and shape of the bounding boxes, bubbles and contours of the response form.

In embodiments, the image-processing library may be any kind of image processing library or set of libraries capable of both OMR and OCR. As an example, the image-processing library may be OpenCV, an open-source image-processing library.

According to the methods and systems of the present disclosure, the accuracy of an OMR scan of a response form image 502 may be determined by comparing the results 506 of the OMR scan 504 to the user-generated external dataset. Based on this result it may be determined 508 whether or not to initiate an OCR scan 510 of the same response form in order to search for marks that may not have been recognized by the OMR scan. The OCR scan may be employed in an unconventional manner, for example the OCR scan may search for a unique symbol—called the response Reverse-Indicator Symbol (RIS) 204 printed inside each bubble 202 on the response form. If the RIS is found within a given bubble 512, then it is determined 514 that a response mark is not present in that bubble based at least in part on the determination that the response mark would obscure the appearance of the RIS. If, on the other hand, the RIS is not found within a given bubble, then it is determined 516 that a response mark must be present, because something is obscuring the appearance of the RIS.

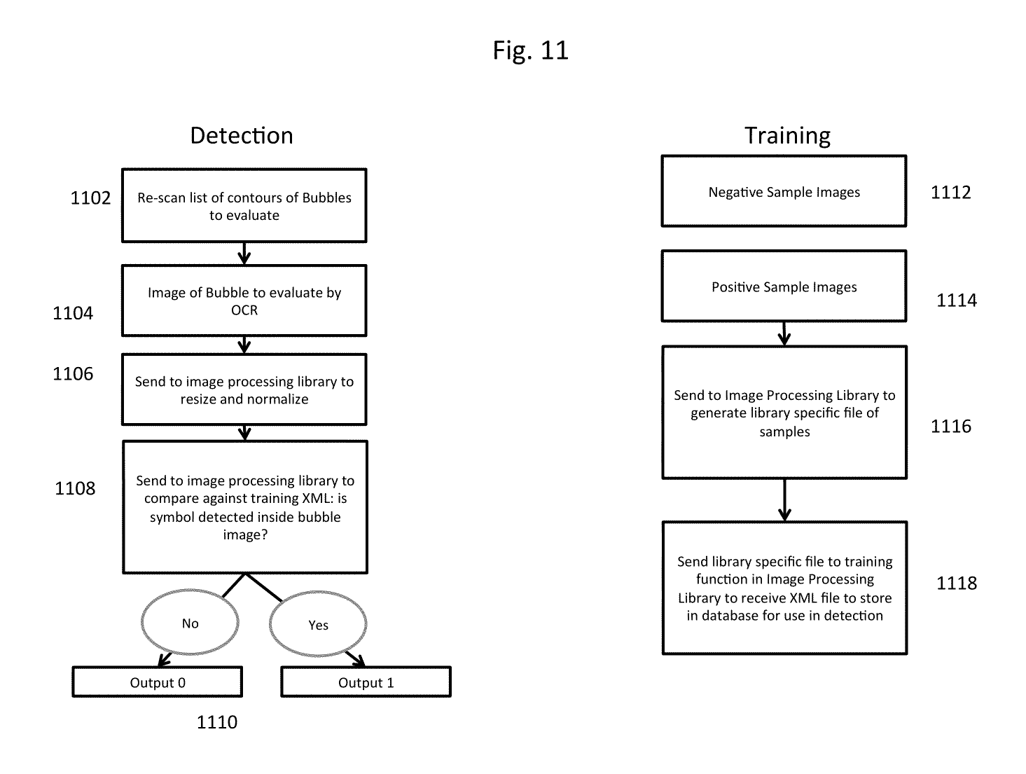

Generating OCR training data may involve negative sample cases. Referring to FIG. 11, during the software development process, the scanner may scan a set of “negative” sample images 1112 that are not images of the RIS. These negative sample images should not contain the RIS that appears inside each bubble on the response form. The negative sample images may include many pictures of completely filled in bubbles, but may also include several arbitrary images that do not include the RIS. The scanner may save these negative samples in the application's database for use by the image-processing library during the OCR analysis.

Generating OCR training data may also involve positive sample cases. Also during the software development process, the scanner may scan a set of “positive” sample images 1114 of the RIS 204. These positive sample images may contain the RIS in a plurality of variations of lighting, viewing angles, levels of focus and so forth. The positive sample images may also include other variations of the RIS.

The method and systems disclosed herein may involve sending sample images to the image-processing library. During the software development process, the positive and negative sample images are sent to the image-processing library being used in the software application. The image-processing library creates a library-specific file 704 that stores the samples in the application's database for use during OCR step (e.g., in OpenCV: opencv_createsamples).

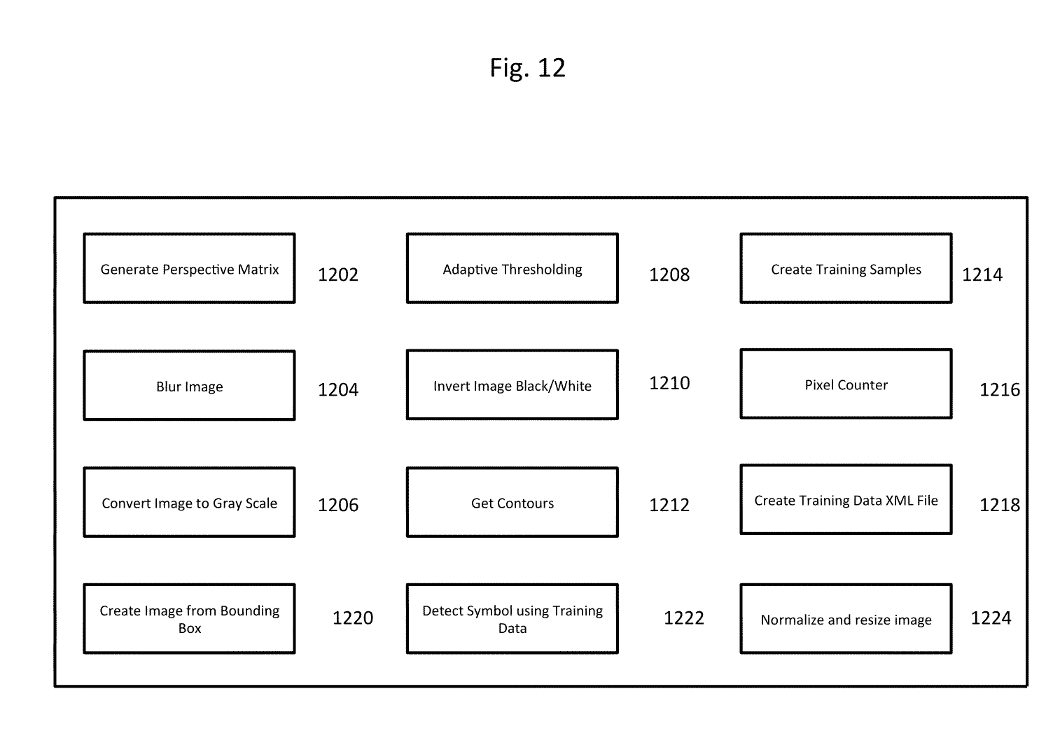

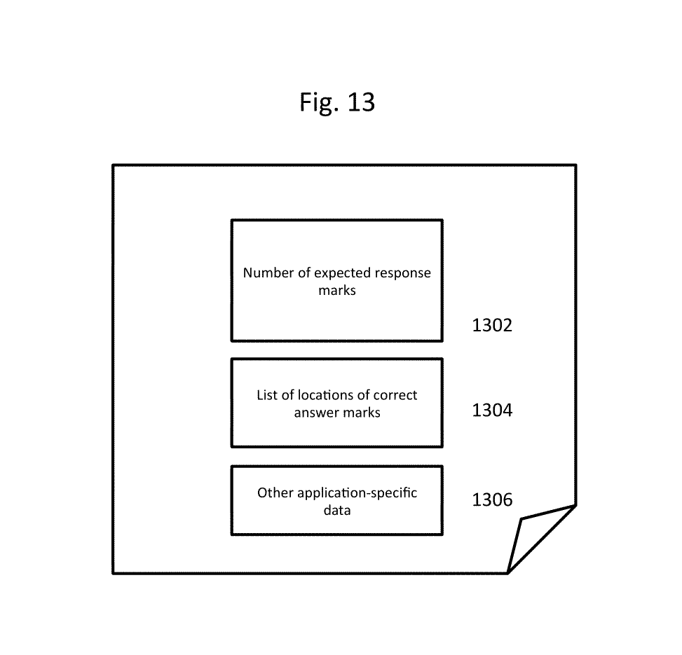

The methods and systems disclosed herein may include generating an OCR XML file. During the software development process, the file of sample images may be used to generate an XML file 1118 that will be used to detect the RIS on response forms. As shown in FIG. 12, this XML file is generated by the image-processing library when it receives the appropriate function call 1218 (e.g., in OpenCV: opencv_traincascade). The XML file may be stored in the application's database 1302, as shown in FIG. 13.

Generating an external dataset may involve various steps. A user of the methods and systems of the present disclosure may generate an external dataset 906 containing a list 1302 of the number of expected marks on the response form. The external dataset may contain the number of questions in the quiz, as well as a list 1304 defining the correct answer to each question, and additional data 1306. In embodiments, the external dataset may be generated at a computer terminal via a Website interface, through a mobile device application on a mobile phone or tablet, or using some other method of database creation. To generate the external dataset a user may choose the number of questions or responses sought and the correct answers by selecting buttons or inputting data via the keyboard.

Storing the external dataset may include saving the external dataset creates a record for the external dataset in a table in the external dataset 404. The external dataset is then available for use by the scanner (scanning software) 610.

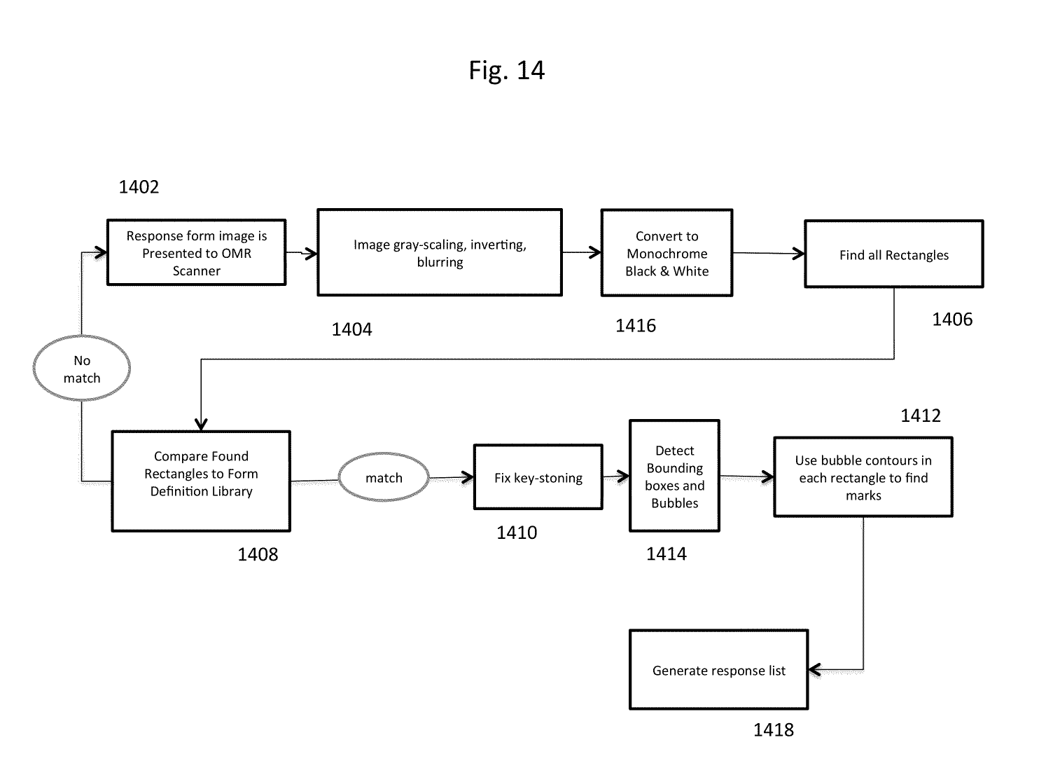

An image of a response form 602 (the original response form image) is next created and may be transformed from a color image to a gray-scale image. As shown in FIG. 14, a function call 1406 may be made to the image-processing library (e.g., in openCV: cvCvtColor) to generate a gray-scale copy of the original image 1404.

The methods and systems disclosed herein may include blurring the image. A function call may be made to the image-processing library (e.g., in openCV: cvSmooth) to create a slightly blurred image 1204, 1404, which removes artifacts due to lighting and other stray pixels that could be misread by the image-processing library.

The methods and systems disclosed herein may include transforming the image from gray-scale to black and white (also known as adaptive thresholding). A function call 1208 is made to the image-processing library (e.g., in OpenCV: cvAdaptiveThreshold) to perform an adaptive thresholding function on the image 1416. The call may include 1) the request to perform the thresholding operation, 2) the threshold value 3) and an optional command 1210 to invert the image (change all black pixels to white, and all white pixels to black) after thresholding. Depending on the image-processing library being used, other parameters may be required. The thresholding value determines the darkest shade of gray that will be turned to white by the function, and the corresponding lightest shade of gray that will be turned black by the function. The image-processing library then performs the thresholding task. All values that are darker than the threshold become white, and all lighter ones become black. The result is a monochrome black and white image that can be processed by future operations. If the call included an inversion command, then the image-processing library may invert the image. In the present example, the image is inverted after thresholding.

Determining the outlines of all bounding boxes on response form: By convention, an OMR response form is bounded by a rectangular bounding box 404 that encloses the entire area of the response form to be scanned by OMR. A response form may contain bubbles 406 or rows of bubbles 402 where marks can be made to provide data for more than one category of data in a database record. For example a response form may contain an area to mark the respondent's ID number, another area for their name, and yet another area where the answers to other questions are marked. The conventional means of identifying these different areas on the response form is to enclose the relevant bubbles by a rectangular bounding box 408. When using this method, each bounding box 404, 408 may be identified so that the image-processing library can properly associate each grouping of bubbles with the appropriate category in the database record. A function call 1212 is made to the image-processing library to find all bounding boxes on the response form image (e.g., in OpenCV: cvFindContours) 1406. The image-processing library then generates a contour output list of contour values 1424, each contour value being a set of points that define the size and shape of any bounding boxes in the response form image.

The values in the contour list output from the image-processing library are next compared 1408 to the expected contour values within the dictionary 904. The output values from the image-processing library are sorted into a list (the output list) so that the order of values in the output list matches the order of values in the dictionary list. The values in each list are then compared to each other. If each value in the output list matches 1420 its corresponding value in the dictionary list within a given margin of error, then the set of values in the output list is defined as matching the dictionary list for a given bounding box. Each bounding box found in the image of the response form can now be assigned to the appropriate data category. Continuing the present example, the bounding boxes enclose bubbles used to mark 1) the respondent identification number and 2) the responses. If the values in the two lists do not match within the pre-set margin of error 1422, then the scanning process is cancelled and may begin again. The scanning process may proceed if the output list contains matching data for all, or some predetermined number, of the expected bounding boxes in the dictionary. If matching data in the output list are found for all of the bounding boxes in the dictionary list, for example, then the scanner ascertains that all expected bounding boxes have been identified by the scanner, and an assumption is made that the image being scanned is an image of the response form expected by the disclosure.

The methods and systems disclosed herein may include correcting for keystoning. Keystoning as use herein refers to the degree to which an image of a rectangle on a response form is not rectangular. Keystoning is often caused by a camera not pointing directly at the response form when the image of the response form is captured. In order for the image-processing library to correctly identify the relative locations of objects, marks, symbols, bounding boxes, bubbles, or other shapes in the image keystoning should be corrected. Correcting any keystoning 1410 will increase the accuracy of the scan and such correction is common practice in OMR. Open-source image processing libraries such as OpenCV, provide keystoning correction for this purpose. OpenCV corrects for keystoning by measuring the amount of keystoning in the original image's bounding boxes, and then using a perspective matrix 1202 to generate a new image in which all of the bounding boxes are rectangular. As part of the keystoning correction process, OpenCV also rotates the image so that all bounding boxes are in the expected rotational orientation (upright). If OpenCV is the image-processing library being used by the OMR scanner, then the function calls to correct for keystoning are: cvGetPerspectiveTransform to generate the matrix, and cvWarpPerspective to apply the perspective matrix.

Detecting the bubbles may include various elements, including the following. The marks on a response form may be made on or in bubbles on the response form. By convention, the scanner makes a series of function calls to the image-processing library to find the lines that define the bubbles 1414. For a given image-processing library, this is often the same call as the one used to detect the bounding contours (bounding boxes) 1212. In the case of OpenCV, the call is cvFindContours. The image-processing library—as with the bounding boxes—finds a set of points that define the boundary of each bubble. This set of points may include the left-most, top-most, right-most, bottom-most, and intermediate points that define the border of each bubble. These calls are made to the image-processing library to find the outlines of the bubbles in each of the bounding boxes defined by the dictionary. In an embodiment, the first call to OpenCV is to find contours of the bubbles inside the bounding box labeled “Student ID,” then a call is made to find the bubbles in the box labeled “answers.” However, it should be understood by one skilled in the art that each bounding box may have any label, depending on the application of the disclosure.

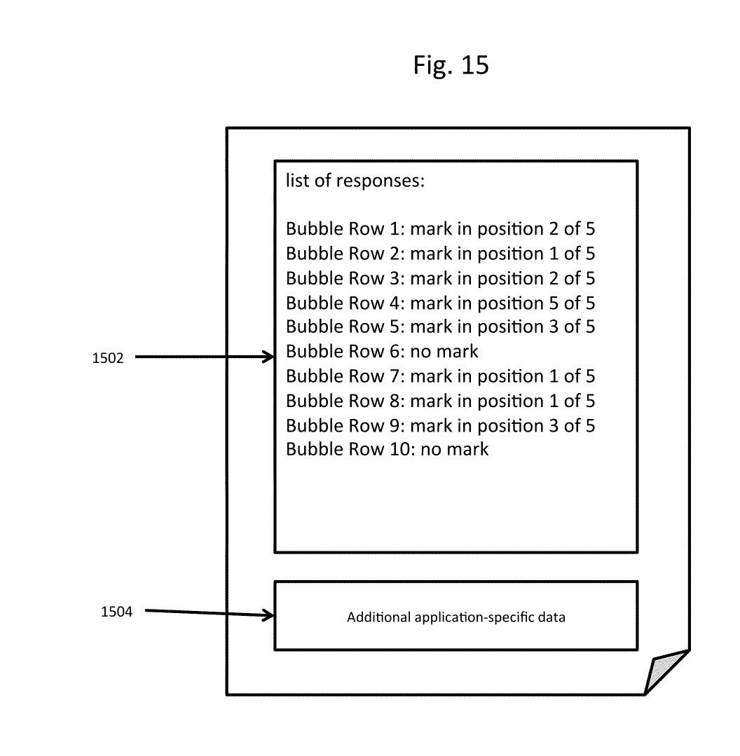

In embodiments, a list of the bubbles on a response from found by the image-processing library is returned to the scanner in the form of a list of points, similar to the list of points defining the bounding boxes. The list of coordinates is then temporarily stored by the scanner. Once the scanner has received the list of bubble coordinates, the scanner then makes a function call 1216 to the image-processing library (e.g., in OpenCV: cvCountNonZero) to find the number of pixels that are black, and the number that are white, within the border of each bubble. The image-processing library returns a list of all the bubbles in the bounding box and the numbers of black and white pixels in each bubble. The scanner next determines what fraction of each bubble has been marked. In an embodiment, where the image of the response form has been inverted, bubbles that have been marked by a respondent, should appear mostly or entirely white. In an embodiment, the scanner may contain a threshold setting. If the fraction, percentage, or number of white pixels in a given bubble is above this threshold setting, then the scanner may label that bubble as having been marked by the respondent 1412. The response list 710 is generated 1418 for the response form image 610 being scanned. As shown in FIG. 15, the response list contains a list 1502 of all of the responses identified by the scanner. In an embodiment, a response may be a choice of one bubble in a row of five bubbles. If no bubble in the row contains more than the threshold number, percentage, or fraction of white pixels (white being the color indicating a mark in this application), then that row in the response list may be recorded as blank or null. It should be understood by one skilled in the art that generating a response list is but one way to handle the recording and storage of responses found by a scan and that a plurality of methods to record and store responses are consistent with and interoperable with the present disclosure's methods and systems, as described herein. The response list may also contain additional data 1504 found or inferred by the scanning process. In an alternate embodiment, the methods and systems of the present disclosure may skip the step of creating a response list as part of determining whether or not a mark is detected in an area where a mark is expected.

Retrieving the external dataset may include various elements. The logical engine receives the external dataset that contains a list of where response marks are expected to be found on the response form. The external dataset defines which bubble rows on the response form should contain a response mark.

In embodiments, the logical engine next analyzes the response list to find any list items with a blank or null value. A blank or null value indicates that no mark was found in a particular bubble or set of bubbles.

The logical engine then compares the null values in the response list with the external dataset's list of expected marks. For each null value in the response list, the logical engine checks to see if the external dataset's list of expected marks also contains a null value for that bubble (or set of bubbles). This may involve cataloging the number and/or location of the items on the response list with the number and/or location of the expected marks, on a bubble-by-bubble basis or for a set of bubbles (for a single question or a set of questions).

Determine the accuracy of the OMR scan may include various elements. If both the response list and the list of expected marks contain a null value for a given area, the logical engine then determines the OMR scan accurately scanned the area and no mark is present in that area. If the list of expected marks indicates that a mark is expected where the response list shows a null value, then the logical engine determines that the OMR scan may have failed to recognize a mark in that area.

Various decisions may be made based on the foregoing. In one such decision, one may apply the response list to the application's database. If marks are found where expected according to the external dataset's list of expected marks, then the logical engine releases the response list to the application. Releasing the response list entails writing the response list to the database and populating the response list record with all other necessary data values as needed by the application. The response list is now ready for use by the application.

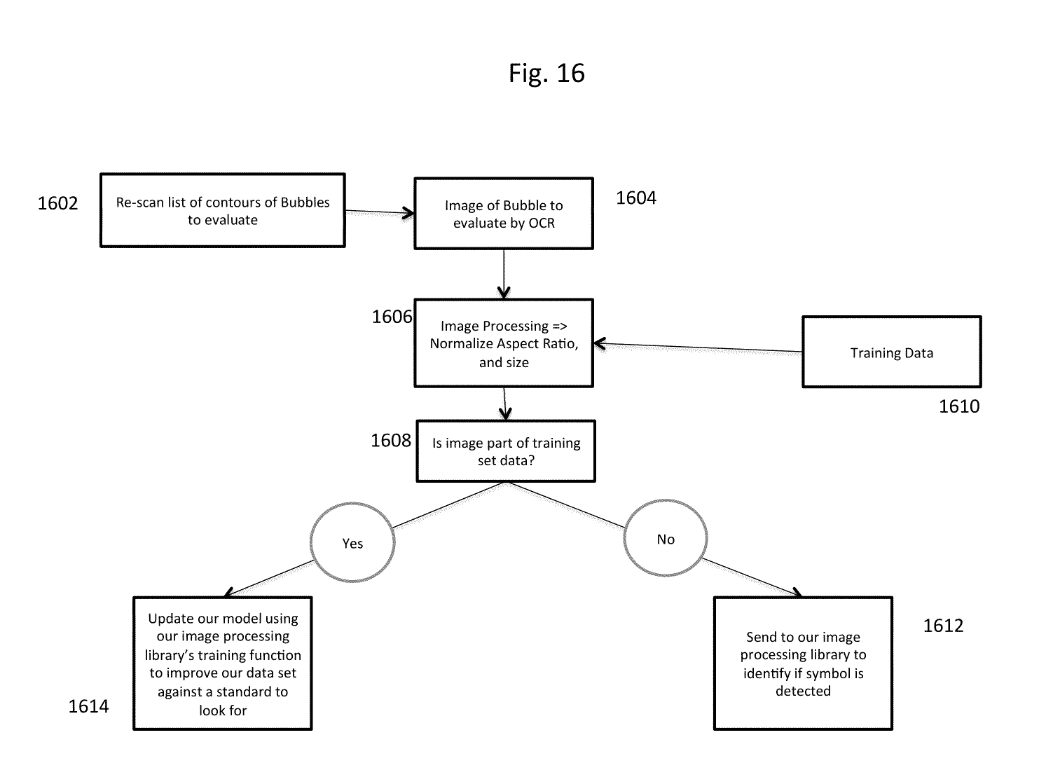

In another decision process, one may continue analysis using OCR and create re-scan list. Referring to FIG. 16, if the logical engine determines that a mark may have been made within a bubble on the response form but was not detected by the OMR scan, then the scanner saves the location of the bubble in question, by storing the contours of each bubble in a list (the re-scan list) 1602.

Retrieving the original response form image may include various elements. Since images are stored in the scanner for the duration of the analysis, the original unadulterated image of the response form is available for a second analysis by OCR.

Creating a bubble image for each bubble in the response form image may include various steps. For each Bubble in the re-scan list, the scanner may use the contour lines to create a bounding box representing the bubble. Using a function call 1220 to the image-processing library (e.g., in OpenCV: cvCreateImage), the scanner converts this bounding box into a separate image 1604. The scanner may make two function calls 1224 to the image-processing library to normalize the aspect ratio and the size 1606 of the generated image of the bubble. As an example, in OpenCV the function calls are OpenCV: cvResize and OpenCV: cvNormalize.

For each bubble image, the scanner attempts to detect the symbol in the image, by using a function call 1222 to the image-processing library (e.g., in OpenCV: detectMultiScale). The image-processing library compares the bubble image to the training image file 1608 and looks for a match. The function call returns the number of symbols that it detects within each bubble image. In an example, this value may be either a 0 (no symbol detected) or 1 (symbol is detected) 1610. The image-processing library may use the XML file 1616 of negative and positive sample images which was created during the software development process, and which is stored in the database 1612

Various scenarios for detection are possible. In scenario A, a symbol is detected. If the scanner detects the symbol (the function call returns a value of 1), then the scanner concludes 1608 there is no mark inside that bubble. The scanner inputs a value of zero (0) to the OCR response list for that bubble.

In scenario B, a symbol is not detected. If the image-processing library does not detect the symbol (function call returns a value of 0), then the scanner concludes 1608 that the bubble contains a mark that has obscured the symbol. The scanner then modifies the response list by replacing the null (0) value with a value of one (1) for that bubble, indicating that a mark has been made in that Bubble.

In embodiments, one may repeat detection of symbol in bubble image(s). The scanner moves to the next bubble image and attempts to detect the symbol within it, repeating the process as previously described herein. The scanner may selectively analyze those bubbles found to not contain marks even though the external dataset indicates a mark is expected in that bubble. However it will be appreciated by one skilled in the art that the choice of which bubbles to analyze is open to variation in other embodiments of the present disclosure. For example, the OCR symbol detection sequence may be applied to all of the bubbles in the response form image as an added check on the accuracy of the OMR scan.

Once the relevant bubbles have been analyzed for the presence or absence of the symbol within each bubble, the OCR symbol detection sequence is complete and the response list may be updated to include the new results from the OCR scan 518. Releasing the response list entails storing the response list in the database and populating the response list record with other necessary data values as needed by the overall application 520. Following this step, the response list is ready for use by the application.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A method for detecting marked answers for questions, the method comprising:
taking at least one markable answer sheet having a plurality of spaces for answers on the at least one markable answer sheet, each space further comprising a mark recognizable by optical character recognition (OCR) software where each mark comprises a reverse indicator symbol;
scanning the at least one marked answer sheet with optical mark recognition (OMR) software; and
cataloging the number and location of answer marks on the scanned at least one marked answer sheet, wherein if the reverse indicator symbol is detected, the corresponding space is counted as unmarked.

2. A method of claim 1, further comprising:
comparing at least one of the number and location of cataloged answer marks on the scanned at least one marked answer sheet to at least one of the number and location of expected answer marks; and
if the comparison reveals a discrepancy, reviewing the at least one marked answer sheet with the OCR software to determine spaces with marks recognized by the OCR software.

3. The method of claim 2, further comprising correcting the number of answer marks recognized to account for the expected number of marks.

4. The method of claim 1, further comprising generating a dataset corresponding to correct answers for responses on the answer sheet, the dataset used to determine correctness of answers marked on the at least one marked answer sheet.

5. The method of claim 1, further comprising generating OCR training data to improve the OCR software.

6. The method of claim 1, wherein the step of scanning generates a scanned image and further comprising correcting the scanned image for keystoning.

7. The method of claim 6, further comprising transforming the scanned image from gray-scale to a black-and-white image.

8. The method of claim 1, wherein the steps of scanning, counting, comparing the number, reviewing and comparing the sum are accomplished with a hand-held device.

9. The method of claim 8, wherein the hand-hand device comprises a smart phone, a cellular phone, a tablet computing device or a portable computing device.

10. A method for detecting marked answers for questions, the method comprising:
providing at least one markable answer sheet, the at least one markable answer sheet comprising a plurality of spaces to mark answers for the questions, wherein each of the plurality of spaces further comprises a character recognizable by optical character recognition (OCR) software;
scanning the at least one marked answer sheet with optical mark recognition (OMR) software;
counting a number of answer marks recognized by the OMR software on the at least one marked answer sheet;
reviewing the at least one scanned marked answer sheet with OCR software to determine a number of characters recognized by the OCR software in the plurality of spaces;
determining a number of answers on the at least one marked answer sheet and a number of unmarked spaces; and
determining a number of questions not answered by comparing the number of answers on the at least one marked answer sheet and the number of characters recognized in the plurality of spaces.

11. The method of claim 10, further comprising resolving any discrepancy between the number of answers determined and the expected number of answers on the at least one marked answer sheet.

12. The method of claim 10, wherein the OMR software is adapted for recognizing markings made on the markable answer sheet by at least one of a pencil, an ink pen and a dry-erase marker.

13. The method of claim 10, wherein the markable answer sheet is suitable for at least one of an educational assessment, a political survey, a consumer survey and a data collection project.

14. The method of claim 10, wherein the plurality of spaces comprise fillable bubbles on the markable answer sheet.

15. A system for detecting marked answers, the system comprising:
at least one processor having access to a non-volatile memory;
a computer program stored in the non-volatile memory, the computer program comprising software suitable for scanning a marked answer sheet, the computer program including software suitable for optical mark recognition (OMR) and optical character recognition (OCR);
a scanner in operable connection with the at least one processor, the scanner suitable for capturing an image; and
a library stored in the non-volatile memory or other memory accessible to the at least one processor, the library comprising a plurality of images of characters recognizable by OCR software,
wherein the scanner is suitable for capturing an image of at least one marked answer sheet, the at least one marked answer sheet comprising a plurality of spaces for answers, each of the plurality of spaces including a mark recognizable by the OCR software, and
wherein the system is suitable for cataloging the number and location of answers marked on the at least one answer sheet with the OMR software and for cataloging a number of characters in the plurality of spaces recognizable by the OCR software.

16. The system of claim 15, wherein the software is suitable for summing the number of spaces marked on the at least one answer sheet and for summing the number of characters counted in the plurality of spaces recognizable by the OCR software.

17. The system of claim 15, further comprising software stored in memory accessible to the at least one processor, the software suitable for transforming a scanned image from gray-scale to black and white.

18. The system of claim 15, further comprising software stored in memory accessible to the at least one processor, the software suitable for correcting keystoning of scanned images.

19. The system of claim 15, further comprising software stored in memory accessible to the at least one processor, the software suitable for determining bounding boxes on the at least one answer sheet.

20. The system of claim 15, wherein the answer sheet is suitable for at least one of an educational assessment, a political survey, a consumer survey and a data collection project.

21. The system of claim 15, wherein the system is mounted within a mobile device.

22. The system of claim 21, wherein the mobile device selected from the group consisting of a mobile phone, a smart phone, a tablet computer and a portable computer.

23. An article of commerce, comprising:
a markable answer sheet having a plurality of spaces for answers on the at least one markable answer sheet, at least a portion of the plurality of spaces further comprising a mark recognizable by optical character recognition (OCR) software, wherein at least a portion of the marks comprise a reverse indicator symbol and wherein the reverse indicator symbol is positioned such that if the reverse induction symbol is detected, the corresponding space is to be counted as unmarked by the OCR software.
